(19) United States
(12) Patent Application Publication
(10) Pub. No.: US 2026/0170324 A1
(43) Pub. Date: Jun. 18, 2026

(54) INJECTED SELF-SPECULATIVE DECODING IN GENERATIVE ARTIFICIAL INTELLIGENCE MODELS

(71) Applicant: QUALCOMM Incorporated, San Diego, CA (US)

(72) Inventors: Raghavv GOEL, San Diego, CA (US); Mingu LEE, San Diego, CA (US); Wonseok JEON, San Diego, CA (US); Mukul GAGRANI, Milpitas, CA (US); Junyoung PARK, Palo Alto, CA (US); Christopher LOTT, San Diego, CA (US)

(21) Appl. No.: 19/317,555

(22) Filed: Sep. 3, 2025

Related U.S. Application Data
(60) Provisional application No. 63/733,128, filed on Dec. 12, 2024.

(51) Int. Cl. G06N 3/08

(52) U.S. Cl. CPC G06N 3/08

(57) ABSTRACT

Techniques and apparatus for generating a response to an input prompt using efficient self-speculative decoding in a generative artificial intelligence model. An example method generally includes receiving an input prompt for processing. A forecast embedding representing one or more forecasted tokens responsive to the input prompt is generated. Generally, the one or more forecasted tokens include tokens speculatively decoded by a generative artificial intelligence model based on generation of an initial response token in response to the input prompt. A bias parameter for the input prompt is determined. Generally, the bias parameter includes an embedding representation representing an error metric between the one or more forecasted tokens and an accepted set of tokens responsive to the input prompt. Using the generative artificial intelligence model, a response to the input prompt is generated based on the input prompt, the forecast embedding, and the bias parameter, and the generated response is output.

### CROSS-REFERENCE TO RELATED APPLICATION

The present application claims the benefit of priority to U.S. Provisional Patent Application No. 63/733,128, filed Dec. 12, 2024 and entitled “Injected Speculative Decoding in Autoregressive Generative Artificial Intelligence Models,” which is hereby incorporated by reference herein in its entirety for all applicable purposes.

### INTRODUCTION

Aspects of the present disclosure relate to generative artificial intelligence models, and more specifically to speculative decoding in generative artificial intelligence models (also referred to as “generative machine learning models” or “generative models”).

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image from an input text description of the content of the desired image, decision transformers, in which future actions are predicted based on sequences of prior actions within a given environment, or the like.

Generally, generating a response to an input prompt using generative artificial intelligence models may be computationally expensive. For example, in a chatbot deployment in which a large language model is used to generate a response to a query formatted as a text query, a response to the query may be generated using a pass through the large language model for each token (e.g., a word or part of a word) generated as part of the response. The output of each pass may be a probability distribution on a set of tokens (e.g., words or parts of words) from which the next token (e.g., a word or part of a word) may be selected, for example, by sampling or based on maximum likelihood. Because a pass through a large language model is used to generate each word (or token(s)) in a response to a query in such cases, the computational expense may be modeled as the product of the number of words included in the response and the computational resource expense (e.g., in terms of processing power, memory bandwidth, and/or other compute resources used) of performing a pass through the large language model, which generally increases as the number of parameters within the large language model increases.

### BRIEF SUMMARY

Certain aspects of the present disclosure provide a method for generating a response to an input prompt using a generative artificial intelligence model. An example method generally includes receiving an input prompt for processing. A forecast embedding representing one or more forecasted tokens responsive to the input prompt is generated. Generally, the one or more forecasted tokens include tokens speculatively decoded by a generative artificial intelligence model based on generation of an initial response token in response to the input prompt. A bias parameter for the input prompt is determined. Generally, the bias parameter includes an embedding representation representing an error metric between the one or more forecasted tokens and an accepted set of tokens responsive to the input prompt. Using the generative artificial intelligence model, a response to the input prompt is generated based on the input prompt, the forecast embedding, and the bias parameter, and the generated response is output as a response to the input prompt.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example pipeline for self-speculative decoding in generative artificial intelligence models, in which certain aspects of the present disclosure may be practiced.

FIG. 2 illustrates example architectures for self-speculative decoding in generative artificial intelligence models, in which certain aspects of the present disclosure may be practiced.

FIG. 3 illustrates an example pipeline for efficient self-speculative decoding using a generative artificial intelligence model and based on forecasted embedding inputs and an injected bias parameter, according to certain aspects of the present disclosure.

FIG. 4 illustrates an example of generating a response to a textual input prompt using efficient self-speculative decoding based on forecasted embedding inputs and an injected bias parameter, according to certain aspects of the present disclosure.

FIG. 5 illustrates an example pipeline for training a generative artificial intelligence model for efficient self-speculative decoding, according to certain aspects of the present disclosure.

FIG. 6 illustrates example operations for efficient self-speculative decoding in generative artificial intelligence models based on injected forecasted embedding inputs and injected bias parameters, according to certain aspects of the present disclosure.

FIG. 7 illustrates an example processing system on which certain aspects of the present disclosure may be performed.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently generating responses to input prompts using generative artificial intelligence models, such as large language models (LLMs) or large multimodal models (LMMs).

Generally, generative artificial intelligence models generate a response to a prompt (also referred to as a query) input into the model. For example, a large language model (LLM) deployed within a chatbot can generate a response to a prompt using multiple passes through the large language model, with each successive pass being based on the prompt (which may be tokenized for processing) and the tokens (or words) generated using previous passes through the large language model. Generally, these large language models may include a large number (e.g., billions or trillions) of weights or parameters within the model. Because of the size of these models and the operations performed on each token to predict what should be the next token generated in response to a prompt and the previously generated tokens, it may be challenging to deploy large language models on a variety of devices which have limited memory, storage, and/or processing capabilities relative to cloud compute instances on which large language models typically operate. Further, in some cases, the memory bandwidth involved in generating a response to a prompt provided as input into a model may prevent compute resources from being used for other tasks.

To improve the efficiency and throughput of large language models, speculative decoding techniques allow for a smaller language model, sometimes known as a draft large language model (or as a draft model, an approximation model, or a second/secondary model), to execute (e.g., sequentially or in parallel) with a larger language model, sometimes known as a target large language model (or as a target model or first/primary model). In such a case, the draft model can speculatively generate additional tokens in sequence and probabilities used for sampling these additional tokens based on a current set of accepted tokens. The target model can generate tokens based on the tokens generated by the draft model. To generate a result, the target model can perform rejection sampling on a per-token basis to accept or reject individual tokens generated by the draft model. This rejection sampling may be performed such that the draft model and the target model have similar probability distributions.

In some aspects, the draft model may be a pruned version of the target model chosen such that the draft model and target model have similar probability distributions. In other aspects, the draft model may be a smaller version of the target model (e.g., trained on millions of tokens, instead of hundreds of millions or billions of tokens).

Generating responses to a prompt input into an LLM using speculative decoding techniques in which a single model speculatively generates tokens in response to the prompt and verifies previously generated tokens may be referred to herein as “self-speculative decoding.” With self-speculative decoding techniques, a model can speculatively generate one or more tokens and speculatively generate additional tokens based on varying numbers of speculatively generated tokens that are verified by the model. By using the same model to speculatively generate tokens in response to a prompt and to perform verification of (e.g., rejection sampling on) the speculatively generated tokens, certain aspects of the present disclosure can reduce the computational expenditure involved in training and using generative artificial intelligence models relative to the use of multiple separately trained models for speculatively generating tokens and performing verification of the speculatively generated tokens. Further, the rate at which tokens are generated may be maximized, or at least increased, with self-speculative decoding as compared to other speculative decoding techniques.

### Speculative Decoding in Generative Artificial Intelligence Models

Generally, autoregressive token generation (e.g., in large language models) may take historical tokens as an input in order to generate an output. That is, autoregressive token generation may be represented by the expression:

$${x}_{t} \sim p ( x \vert {x}_{0} , {x}_{1} , … , {x}_{t - 1} ) \to {x}_{t + 1} ∼ p ( x \vert {x}_{0} , {x}_{1} , … , {x}_{t - 1} , {x}_{t} )$$

where xₜ represents a sequence of tokens generated at time t, having a conditional probability p conditioned on the selection of tokens x₀ through xₜ₋₁, and xₜ₊₁ represents a sequence of tokens generated at a subsequent time t+1, having a conditional probability p conditioned on the selection of tokens x₀ through xₜ. Generally, a single additional token may be generated each time an autoregressive model is executed, which means that N inferences may be performed to generate a sequence of N tokens. As discussed above, speculative decoding techniques can be used to accelerate token generation by using a draft model, smaller in size than the target model, that speculatively generates tokens faster than the target model, with the target model being used to verify the tokens (speculatively) generated by the draft model.

In a speculative decoding pipeline, the draft model may speculatively generate n tokens autoregressively, according to the expression:

$${x}_{t + 1}^{draft} ∼ {p}_{t}^{draft} = {p}^{draft} ( x \vert {x}_{0} , … {x}_{t} ) , {x}_{t + 2}^{draft} ∼ {p}_{t + 1}^{draft} , … , {x}_{t + n}^{draft} ∼ {p}_{t + n - 1}^{draft}$$

where t corresponds to a point in time,

$${p}_{t}^{draft}$$

corresponds to the conditional probability distribution associated with a selected token x at time t conditioned on the selection of tokens x₀ through

$${x}_{t - 1} , and {x}_{t}^{draft}$$

represents a token x speculatively generated at time t by the draft model.

The target model may take the generated n tokens and process the n tokens in parallel to generate probability distributions for each of the n tokens, according to the expression:

$$[ {p}_{t}^{target} , {p}_{t + 1}^{target} , ... , {p}_{t + n}^{target} ] = {[ {p}^{target} ( x \vert {x}_{0} , ... {x}_{t} , {x}_{t + 1}^{draft} , ... , {x}_{t + k}^{draft} ) ]}_{k = 1 , 2 , … , n}$$

where k corresponds to a token index relative to the generated n tokens and

$${p}_{t}^{target}$$

corresponds to a probability distribution generated by the target model at time t for the tokens x generated by the draft model.

The target model can then verify the tokens generated by the draft model by comparing distributions from the draft model and target model to determine whether a token is accepted or rejected. A given token

$${x}_{t + k}^{draft}$$

may be accepted when

$$f ( {p}_{k}^{draft} , {p}_{k}^{target} ) < α ,$$

for some function ƒ and some threshold α (also know as an acceptance rate). Otherwise, the token may be rejected. The final token may then be generated at the first rejection position or at the last position n based on some function

$$g ( {p}_{k}^{draft} , {p}_{k}^{target} ) .$$

Speculative decoding, with an acceptance rate of α, may result in cost reductions relative to using a single autoregressive model to iteratively generate tokens, one token per iteration. Inference cost savings, relative to autoregressive iterative token generation, may be represented by the expression:

$${C}^{AR} = N {C}^{target} \to {C}^{SD} = nN {C}^{draft} + \frac{N}{α + 1} {C}^{target}$$

where N corresponds to a number of tokens, C^{AR} corresponds to a computational cost of generating an inference using an autoregressive model, a corresponds to an acceptance rate, C^{target} corresponds to a computational cost of generating a set of tokens using the target model, C^{draft} corresponds to a computational cost of generating a set of tokens using the draft model, C^{SD} corresponds to a computational cost of speculatively generating a set of tokens using the draft model with speculative decoding, and n corresponds to a number of tokens generated speculatively in a single pass through an autoregressive model. Consider an example in which N=1000, C^{target}=10, C^{draft}=1, n=4, and α=3. In such an example, speculative decoding may result in a 35% reduction in computational expense relative to autoregressive iterative token generation alone.

However, speculative decoding on a per-token basis, as discussed, may impose limits on the rate at which tokens are generated, as a first token may be sampled individually by a draft model and then verified by a target model before the next token is sampled by the draft model and verified by the target model. That is, generating a response to an input prompt using per-token speculative decoding techniques may involve executing the draft model and target model for each token generated as part of a response to the input prompt, which may use significant amounts of computational resources (e.g., processor time, memory, memory bandwidth, etc.) in order to generate the response.

### Example Self-Speculative Decoding in Generative Artificial Intelligence Models

In some aspects, speculative decoding, may be achieved using a single generative artificial intelligence model that combines the functionality of a draft model used to speculatively generate tokens and a target model used to verify and accept the speculatively generated tokens. In doing so, draft token generation, target token generation, and token acceptance may be parallelized in a single generative artificial intelligence model. Using a single generative artificial intelligence model may, for example, reduce the computational expense involved in generating both a target model and a draft model, increase the performance of generative tasks by executing token verification and speculative generation in one pass through the single generative artificial intelligence model, reduce the amount of memory used in storing models used for speculative decoding in generative tasks, and so on.

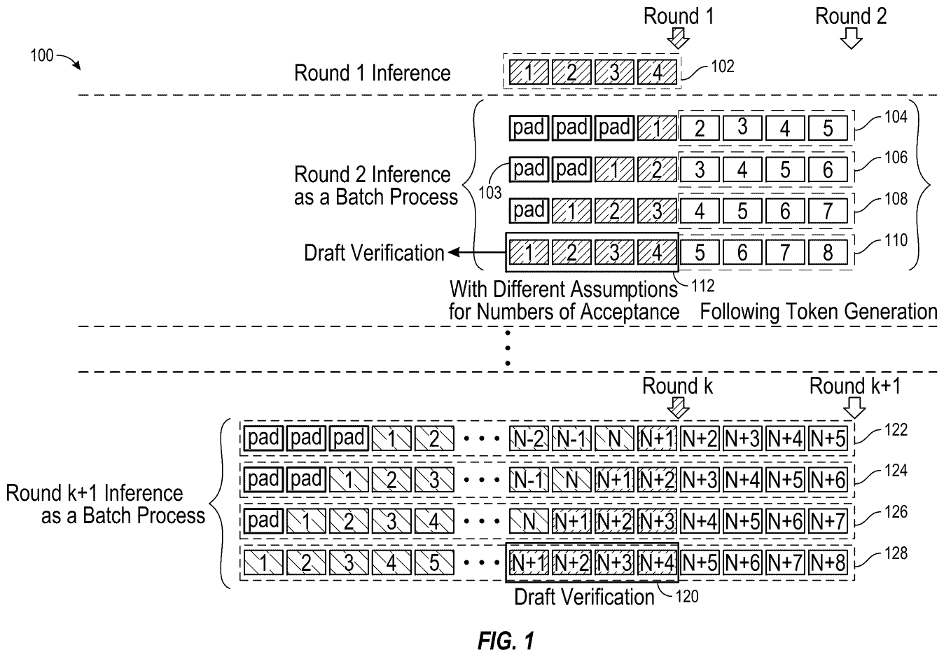

FIG. 1 illustrates an example pipeline 100 for self-speculative decoding in generative artificial intelligence models, in which certain aspects of the present disclosure may be practiced.

As illustrated, the pipeline 100 uses a single generative artificial intelligence model to speculatively generate tokens and verify the speculatively generated tokens. During a first inference round in the pipeline 100, a first set of tokens 102 is speculatively generated. As illustrated, for example, the first set of tokens 102 may include tokens 1 through 4 and may be provided as input during a second round in the pipeline 100 to speculatively generate the next set of tokens as a batch process in which multiple sets of tokens are generated. While the first set of speculatively generated tokens 102 is processed by the single generative artificial intelligence model, the single generative artificial intelligence model continues to speculatively generate a plurality of second sets of draft tokens 104, 106, 108, and 110 in a second inference round in the pipeline 100.

In generating the second sets of draft tokens 104, 106, 108, and 110, assumptions may be made for different numbers of accepted tokens from the first set of tokens 102. For example, as illustrated, the second set of draft tokens 104 may assume acceptance of the first draft token from the first set of tokens 102 and may include a speculatively generated set of tokens based on acceptance of the first token. The second set of draft tokens 106 may assume acceptance of the first and second draft tokens from the first set of tokens 102 and include a speculatively generated set of tokens based on acceptance of the first and second tokens. The second set of draft tokens 108 may assume acceptance of the first through third draft tokens from the first set of tokens 102 and include a speculatively generated set of tokens based on acceptance of the first through third tokens. Finally, the second set of draft tokens 110 may assume acceptance of all four tokens from the first set of tokens 102 and include a speculatively generated set of tokens based on acceptance of all four tokens. In various aspects, for the cases in which fewer tokens than the number of tokens included in the first set of tokens 102 are assumed to be accepted, padding 103 (e.g., null values, predefined constants, etc.) can be added so that each assumption is of the same length.

Once the single generative artificial intelligence model completes rejection sampling on the speculatively generated set of tokens, the single generative artificial intelligence model selects the set of speculatively generated tokens associated with the set of accepted tokens from the first set as input to the single generative artificial intelligence model for another inference round in which tokens are speculatively generated using the single generative artificial intelligence model. In this example, it may be seen that all four tokens in the first set of tokens 102 have been accepted by the single generative artificial intelligence model as a draft verification 112, and thus, the set of tokens 110 may be used for further speculative generation of tokens using the single generative artificial intelligence model.

The process above may be continued until a terminating event occurs. Successive rounds of speculative generation may be based on assumptions of the number of tokens from a previous round of speculative generation being accepted by the single generative artificial intelligence model. For example, as illustrated in FIG. 1, sets of draft tokens 122, 124, 126, and 128 may be generated in the k+1^{th} round of inferencing with the tokens included in the sets of draft tokens being based on a number of speculatively generated tokens beyond the N accepted tokens generated in the k^{th} round of inferencing. In this example, it may be seen that the four speculatively generated tokens generated during the k^{th} round of inferencing have been accepted as a draft verification 120, and the tokens N+5 through N+8 may be used for further speculative generation of tokens using the single generative artificial intelligence model.

In some aspects, the terminating event may include the generation of a special token used to denote the end of a response (e.g., that no further tokens can plausibly be included in a response due to the probabilities associated with these tokens falling below a threshold probability value for acceptance). The terminating event may, in other aspects, be reached when a threshold number of tokens have been generated.

In some aspects, when all tokens from a previous round of speculative token generation are rejected by the single generative artificial intelligence model, the process can restart with the last set of accepted tokens, plus a token sampled from a final distribution (e.g., as discussed above), being provided as input into the single generative artificial intelligence model.

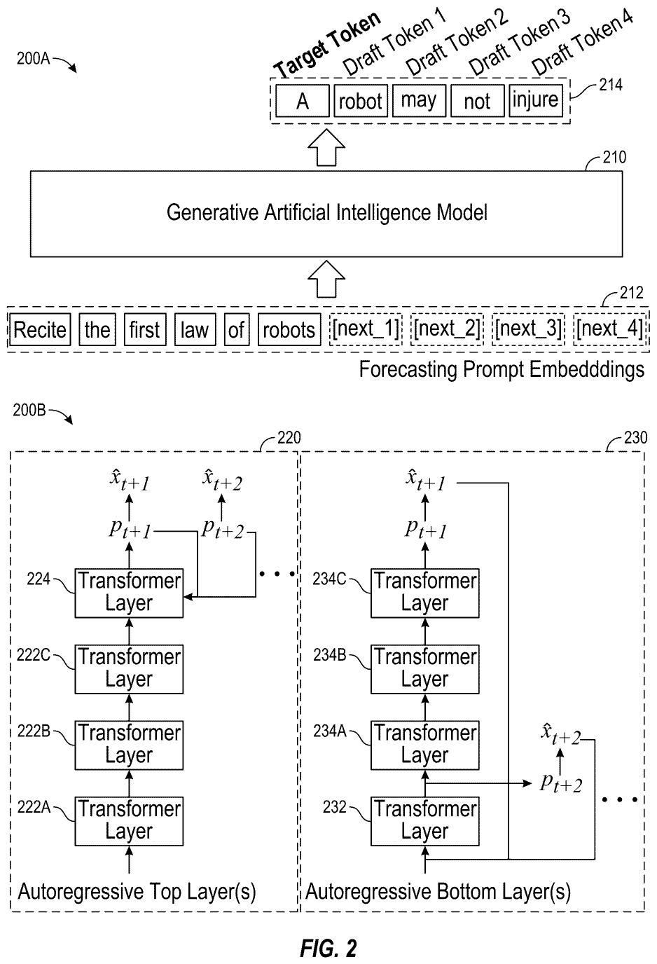

FIG. 2 illustrates example architectures 200A, 200B for self-speculative decoding in generative artificial intelligence models, in which certain aspects of the present disclosure may be practiced. The example architectures 200A and 200B may both allow for the generation of multiple tokens in any pass through the model, such as in the generation of tokens illustrated in FIG. 1, as discussed above.

In the example architecture 200A, a generative artificial intelligence model 210 may be trained to generate multiple forecast prompt embeddings 212, appended to an input set of tokens, to allow for parallel generation of multiple output tokens 214. These forecast prompt embeddings 212 may be embeddings that correspond to tokens that are included in a response to an input prompt (including any previously generated and accepted tokens). The generative artificial intelligence model 210 may be any of various suitable generative artificial intelligence models, such as a pre-trained LLM or other pre-trained generative artificial intelligence model, updated using various fine-tuning techniques. For example, a generative artificial intelligence model used to generate textual responses to textual inputs (also known as an LLM) may be updated or fine-tuned using techniques such as low-rank adaptation (LoRA) of large language models.

In the example architecture 200B, a generative artificial intelligence model may be implemented as a partial autoregressive model. Inference operations, used to speculatively generate tokens, may be performed using a subset of layers in the partial autoregressive model (e.g., the top n layers of the model and/or the bottom n layers of the model). In doing so, the layers used to speculatively generate tokens may create context that may allow for causality and/or other relationships to be modeled for the speculatively generated tokens. These tokens may be fed as input into the portion of the model that verifies the tokens as valid responses to the input prompt.

The architecture 200B may be implemented in various manners such that autoregressive inference—and the generation of multiple sets of tokens for acceptance and/or rejection—can be generated using a small number of autoregressive layers in a generative artificial intelligence model. In example implementation 220, a generative artificial intelligence model may include a plurality of non-autoregressive layers 222A-222C and an autoregressive layer 224. The layers in the generative artificial intelligence model may be organized into a stack, with the lowest layer in the stack corresponding to the layer that receives an input for processing and the highest layer in the stack corresponding to the layer that generates an output. In the implementation 220, the non-autoregressive layers 222A-222C may be placed at the bottom of the stack, and the autoregressive layer 224 may be placed at the top of the stack.

In contrast, in example implementation 230, the layers of the generative artificial intelligence model may be organized such that an autoregressive layer 232 is placed at the bottom of the stack and non-autoregressive layers 234A-234C are placed at the top of the stack.

In various aspects, the autoregressive layers 224 and/or 232 may operate, for example, in a loop to continually generate and accept tokens to be output as a response to an input prompt (and, in some aspects, previously generated tokens included as a partial response to the input prompt).

### Example Efficient Self-Speculative Decoding in Generative Artificial Intelligence Models

As discussed, self-speculative decoding allows for the use of a single generative artificial intelligence model acting as both the draft model and the target model to generate a response to an input prompt. By using a single generative artificial intelligence model as the draft model and the target model in generating a response to an input prompt, self-speculative decoding may allow for increases in the speed at which generative artificial intelligence models generate a response to an input prompt.

To further increase the speed at which tokens are generated using self-speculative decoding techniques and allow self-speculative decoding techniques to be used in generative artificial intelligence models that generate an output from an input prompt, certain aspects of the present disclosure provide techniques for generating tokens based on injected speculative embedding inputs into a generative artificial intelligence model (referred to herein as “injected speculative decoding (ISD),” “efficient self-speculative decoding,” “injected on-the-fly self-speculative decoding (IOSD),” or “online self-speculative decoding”).

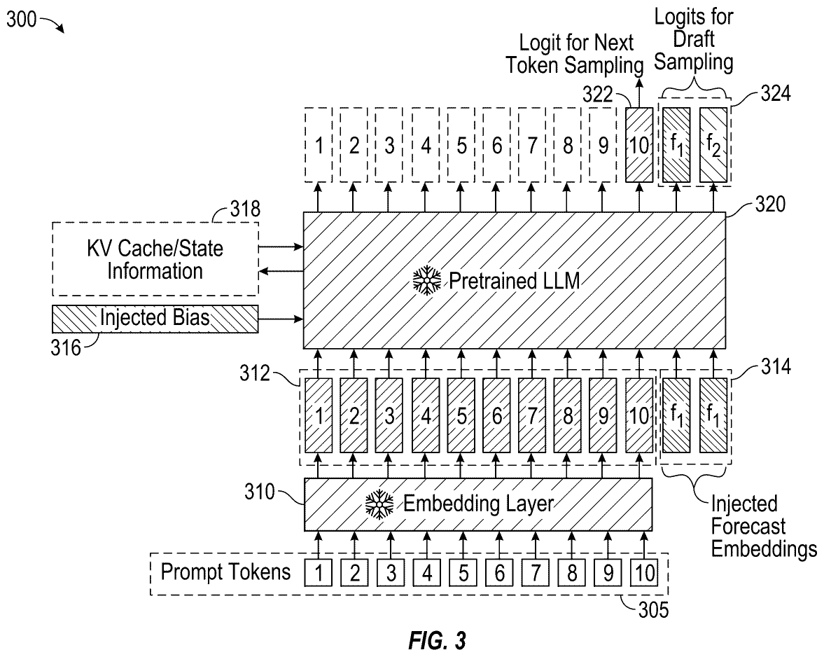

FIG. 3 illustrates an example pipeline 300 for efficient self-speculative decoding in generative artificial intelligence models based on forecasted embedding inputs and an injected bias, according to certain aspects of the present disclosure. As illustrated, the pipeline 300 includes an embedding layer 310 and a pretrained generative artificial intelligence model 320 (labeled as a pretrained LLM in FIG. 3, though it should be understood by one of ordinary skill in the art of machine learning that the generative artificial intelligence model may be any appropriate generative model that is trained to generate a response to an input prompt).

To generate a response in the pipeline 300, the embedding layer 310 may project a tokenized version of an input prompt 305 into a set of embeddings 312 in an embedding space. Although the tokenized version of the input prompt 305 includes ten tokens (labeled “1” through “10”) as shown in FIG. 3, it should be understood that the input prompt 305 may be tokenized into any suitable number of tokens. The embeddings 312 generated from the tokenized version of the input prompt 305 may be accompanied by a number of forecasted token embeddings 314 associated with future predictions of inputs into the generative artificial intelligence model 320.

These forecasted token embeddings 314, for example, may be one or more embeddings associated with predicted tokens corresponding to words or parts of words predicted to be part of an output. This part of the output is subsequently appended to the input prompt for future generation of additional portions of the response to the input prompt in subsequent inferencing rounds using the generative artificial intelligence model 320. In some aspects, the same forecast embedding may be used for multiple forecast tokens, which may reduce the number of trainable parameters for the generative artificial intelligence model 320. Although two forecasted token embeddings 314 (labeled “ƒ₁”) are shown in FIG. 3, it should be understood that any suitable number of forecasted token embeddings 314 may be used. In some aspects, the forecasted token embeddings 314 may be initialized according to the expression z₀=mean(x₁, . . . xₙ), where [x₁, . . . , xₙ] represent input context embeddings from the embedding layer 310. In the example pipeline 300, n=10. For any time step t including n tokens in an internal cache 318 (e.g., in a key-value (KV) cache), the forecasted token embeddings 314 may be updated according to the equation:

$${z}_{t + 1} = ( 1 - {η}_{e , t + 1} ) {z}_{t} + {η}_{e , t + 1} mean ( {x}_{n + 1} , ... , {x}_{n + {n}_{accepted}} )$$

where zₜ₊₁ represents a forecasted token embedding for the next time step and η_{e,t+1} represents a scalar coefficient used in updating the forecasted token embeddings 314. This scalar coefficient ηₑ may be fixed or may vary over time based on a number of items (e.g., tokens, where

$${η}_{e , t + 1} may equal \frac{1}{n + 1} )$$

included in the internal cache 318. Generally, ηₑ may correspond to a rate at which the forecasted token embeddings 314 are updated, similar to a learning rate.

In some aspects, along with the forecasted token embeddings 314, a bias term 316 may be injected into the generative artificial intelligence model 320. The injected bias term 316 generally includes one or more parameters that bias the attention output of an attention head in the generative artificial intelligence model to minimize, or at least reduce, the error between the forecasted token embeddings 314 and the output of the generative artificial intelligence model 320.

In some aspects, the injected bias term 316 may be independent of the internal cache 318, which allows for the injected bias term 316 to aid in predicting an output token while maintaining the size of the internal cache 318. Because the injected bias term 316 does not affect the size of the internal cache 318, the number of operations performed (e.g., key-value-query computations performed in an attention layer) based on the internal cache 318 may not be affected by the injected bias term.

In some aspects, a single injected bias term 316 may be used for each different attention layer or may be used in a subset of attention layers (e.g., every 4^{th} layer or every 8^{th} layer), outside of the attention computation. This single bias term 316 may be used instead of (i.e., without) multiple forecast prefix embeddings appended to the beginning of the input embeddings in the cache 318. Using the injected bias term 316 instead of multiple prefix embeddings may reduce the number of trainable parameters and may provide better computation efficiency.

In some aspects, the injected bias term 316 may be applied across different layers of the pretrained generative artificial intelligence model 320 and may be updated dynamically as the generative artificial intelligence model 320 processes the input prompt 305. For example, the injected bias term b may be initialized based on value vectors (e.g., in a key-value cache, in an input into the generative artificial intelligence model 320, etc.) in a layer I according to the equation:

$${b}^{l} ( 0 ) = mean ( {v}_{1}^{l} , {v}_{2}^{l} , ... , {v}_{p}^{l} )$$

where p represents the number of vectors v (e.g., representing different tokens, key-value pairs, attention function outputs, etc.) involved in performing operations in the layer l of the generative artificial intelligence model 320.

For a time step t resulting in the generation of r tokens, an error e in a layer l between the forecasted token embeddings 314 and the actual token embeddings (e.g., the embeddings generated by and output from the generative artificial intelligence model 320 based on the embeddings 312 and the forecasted token embeddings 314) may be calculated according to the equation:

$${e}^{l} ( t + 1 ) = loss ( {f}_{attn} ( {x}_{r}^{l} \vert {x}_{0}^{l} , ... , {x}_{r - 1}^{l} ) , {f}_{attn} ( {z}_{r}^{l} ( t + 1 ) \vert {x}_{0}^{l} , ... , {x}_{r - 1}^{l} )$$

where ƒₐₜₜₙ(·) represents the output of an attention function, loss(·) is a loss function, and

$${z}_{r}^{l} ( t + 1 )$$

is the hidden state or a reference forecasted token embedding at layer l.

Meanwhile, the injected bias term 316 of layer l may be updated according to the equation:

$${b}^{l} ( t + 1 ) = ( 1 - {η}_{b} ( t + 1 ) ) {b}^{l} ( t ) + {η}_{b} ( t + 1 ) {∇}_{z} {e}^{l} ( t + 1 )$$

where η_{b} represents a scalar coefficient used in updating the injected bias term 316, e represents an error signal used in updating the injected bias term, and ∇_{z} represents a gradient of a loss function. Generally, η_{b} may correspond to a rate at which the injected bias term 316 is updated. Since the injected bias term 316 and/or the injected forecasted token embeddings 314 may be updated on-the-fly, this type of speculative decoding may be referred to as injected on-the-fly self-speculative decoding (IOSD).

In some aspects, the injected bias term 316 may be computed using various loss or error metrics. For example, the injected bias term 316 may be computed based on a cosine similarity between the forecasted token embeddings 314 and embeddings associated with the output of the generative artificial intelligence model 320, a mean-squared error between the forecasted token embeddings 314 and embeddings associated with the output of the generative artificial intelligence model 320, or the like. Gradients with respect to a loss function may act, for example, as an error signal e (t) that is used to update the injected bias term 316, as discussed above.

In some aspects, the injected bias term 316 may be computed based on an error calculated between hidden state information (e.g., based on keys and query information used by the generative artificial intelligence model 320 to generate an output from the embeddings 312 and the forecasted token embeddings 314). For example, proportional-integral-derivative (PID)-based feedback may be used to generate the injected bias term 316, according to the equation:

$${b}^{l} ( t + 1 ) = - {k}_{P} e ( t + 1 ) - {k}_{l} \int e ( t ) - {k}_{D} ( e ( t + 1 ) - e ( t ) )$$

where the k variables (kₚ, kₗ, and k_{D}) represent the scalar coefficients for the PID feedback.

In the equation above, the error signal e(t+1) may be calculated as a loss or difference between the actual output of an attention function in the generative artificial intelligence model and the forecasted token embeddings 314 according to the equation:

$$e ( t ) = {f}_{attn} ( {x}_{r}^{l} \vert {x}_{0}^{l} , ... {x}_{r - 1}^{l} ) - {f}_{attn} ( {z}_{r}^{l} ( t + 1 ) \vert {x}_{0}^{l} , ... {x}_{r - 1}^{l} )$$

Additionally, in calculating b^{l}(t+1), kₚ, kₗ, and k_{D} are greater than zero.

Generally, the forecasted token embeddings 314 may be generated by a machine learning model trained based on minimizing, or at least reducing, a loss function between tokens predicted by the generative artificial intelligence model using the forecasted token embeddings 314 and ground-truth tokens in a training data set. Generally, the forecasted token embeddings 314 may include any number M of forecasted embeddings, and the forecasted token embeddings 314 may be introduced as inputs into the generative artificial intelligence model 320 in conjunction with the embeddings 312 generated from the tokenized version of the input prompt 305. For example, the forecasted token embeddings 314 may be appended: (i) to the end of the embeddings 312 generated from the tokenized version of the input prompt 305 or (ii) after the last token accepted from a previous inferencing round. The number of forecasted tokens for which the generative model is trained may define the maximum draft length during inferencing time.

According to various aspects, in processing the embeddings 312 and the forecasted token embeddings 314, a mask (which may be referred to as a “bias mask”) may be used to control how the injected bias term 316 is processed by the pretrained generative artificial intelligence model 320. Generally, the injected bias term 316 may be masked (e.g., by the bias mask) during processing so that the injected bias term 316 is used by the generative artificial intelligence model 320 in processing the forecasted token embeddings 314 (e.g., in calculating attention for the forecasted token embeddings 314 appended to the embeddings 312 generated from the tokenized version of the input prompt 305), but is not used by the generative artificial intelligence model 320 in processing the tokens corresponding to the embeddings 312 generated from the tokenized version of the input prompt 305 itself. This bias mask may, for example, model dependencies between different types of tokens (e.g., input tokens, prefix tokens, draft tokens, forecast tokens, etc.).

The output of the generative artificial intelligence model 320, as illustrated, may include a plurality of tokens. A first output token 322 (or logit) may be (or may correspond to) a token that is deemed to be valid and accepted by the generative artificial intelligence model 320 during a verification round, as the first token generated by the generative artificial intelligence model 320 may typically be accepted as a valid token responsive to the input prompt. A set of speculatively generated draft tokens 324 (or logits) may also be generated by the generative artificial intelligence model 320, as discussed above. Generally, these speculatively generated draft tokens 324 may be generated based on assumptions that prior tokens are accepted, resulting in the generation of a draft token tree or other data structure in which different sets of tokens (e.g., represented by different navigable paths through a token tree) correspond to different candidate responses to the input prompt.

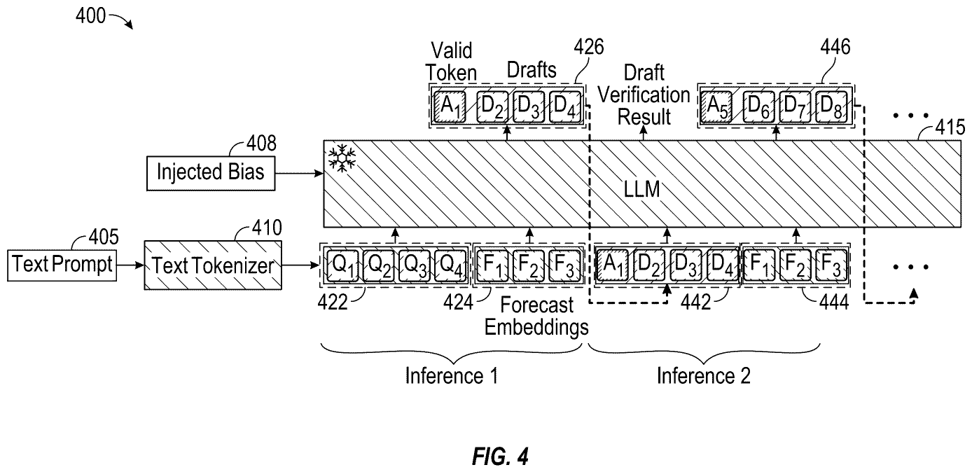

FIG. 4 illustrates an example 400 of generating a response to a textual input prompt 405 using efficient self-speculative decoding based on forecasted embedding inputs and an injected bias (e.g., using efficient self-speculative decoding as described herein with respect to FIG. 3), according to certain aspects of the present disclosure.

As illustrated, in the example 400, the textual input prompt 405 (labeled “Text prompt”) may be received and tokenized into input tokens Q₁ through Q₄ (amongst others, not illustrated in FIG. 4, and collectively referred to herein as “input tokens 422”) by a text tokenizer 410. Embedding representations of the input tokens 422 (which may be generated by an embedding layer (not shown)) may be accompanied by a set of forecasted embedding inputs F₁ through F₃ (amongst others, not illustrated in FIG. 4, and collectively referred to herein as “forecasted embedding inputs 424”) as input into a generative artificial intelligence model 415 (labeled “LLM” in FIG. 4).

As discussed above, the number of forecasted embedding inputs 424 appended to the embeddings corresponding to the tokenized input (e.g., the input tokens 422) may be defined based on the number of forecasted token embeddings with which the generative artificial intelligence model 415 is trained. The generative artificial intelligence model 415 may generate output tokens (both valid and draft tokens) from the embedding representations of the input tokens 422 and the forecasted embedding inputs 424, using the injected bias 408, as explained above. For example, an output 426 of the initial round of inferencing (labeled “Inference 1”) may be a valid token A₁ (since the initial token generated by the generative artificial intelligence model 415 may be deemed valid) and a plurality of draft tokens D, labeled “D₂,” “D₃,” and “D₄” (though it should be understood that any number of speculatively generated draft tokens may be output by the generative artificial intelligence model 415).

In a second inferencing round (e.g., an inferencing round following the initial inferencing round and labeled “Inference 2”), the output 426 of the initial inferencing round, including the valid token A₁ and the draft tokens D₂ through D₄, may be input into the generative artificial intelligence model 415 for verification, as indicated by the dashed arrow. Further, the valid token A₁ and the draft tokens D₂ through D₄ may be accompanied by a new set of forecasted token embeddings F₁ through F₃ (collectively referred to herein as “forecasted token embeddings 444”). Verified tokens 442 from the output set of tokens including A₁ and D₂ through D₄ and the forecasted token embeddings 444 may be input into the generative artificial intelligence model 415 to generate another output 446, using the injected bias 408. The injected bias used in the second inferencing round may be the same or different from the injected bias used in the first inferencing round, depending on whether the injected bias is fixed or varies with time. This output 446, as illustrated, includes a valid token A₅ and a plurality of speculatively generated draft tokens D₆ through D₈.

The process of verifying draft tokens generated during a prior inferencing round and generating a new set of output tokens, including a valid token and a plurality of draft tokens, based on previously generated/verified tokens and forecasted embedding inputs, may continue until a terminating condition is reached. This terminating condition may include, for example, reaching a maximum output length for a response generated by the generative artificial intelligence model 415, the generation and validation by the generative artificial intelligence model 415 of a terminating token indicating that the generative artificial intelligence model 415 has completed generating a response to the input prompt 405, or the like.

In the example 400, as can be seen, multiple tokens may be generated during each inferencing round. By doing so, certain aspects of the present disclosure may increase the token generation rate relative to autoregressive decoding techniques in which a single token is generated during each inferencing round until a terminating condition is reached.

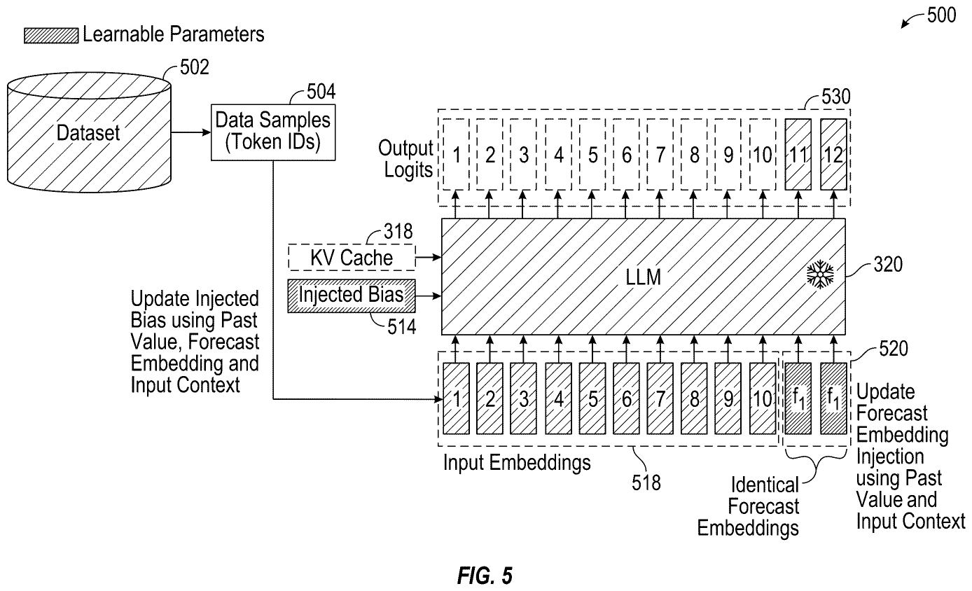

FIG. 5 illustrates an example pipeline 500 for training a generative artificial intelligence model for efficient self-speculative decoding (e.g., a model for efficient self-speculative decoding as described herein with respect to FIGS. 3 and/or 4), according to certain aspects of the present disclosure.

As illustrated, in the example pipeline 500, a training data set 502 may be used to train the generative artificial intelligence model 320 (e.g., a self-speculative decoding parameter predictor portion of the generative artificial intelligence model 320 or 415) to generate one or more forecasted embeddings 520 (labeled “ƒ₁” in FIG. 5) and a bias term 514 based on a loss computation between ground-truth tokens in the training data set 502 and tokens generated based on the forecasted embeddings. Generally, the training data set 502 may include a plurality of example responses to an input prompt. In cases where multiple forecasted embeddings 520 are used, the forecasted embeddings may be identical.

To train the self-speculative decoding parameter predictor portion of the generative artificial intelligence model 320, a portion 518 of a data sample 504 from the training data set 502, along with one or more forecasted embeddings 520, may be input into the generative artificial intelligence model 320 for processing. The generative artificial intelligence model 320 may generate an output 530, which includes (i) a first token that may be deemed a valid token and (ii) one or more tokens after the first token that are speculatively generated tokens. The output 530 may be generated based on cached information in a cache 318 (e.g., a KV cache), as well as the bias term 514 generated by the self-speculative decoding parameter predictor portion.

A loss may be calculated between the forecasted embeddings 520 and the corresponding tokens (labeled “11” and “12” in this example) generated by the generative artificial intelligence model 320 in the output 530. This loss may be backpropagated (e.g., via gradient descent or another backpropagation technique) to refine the self-speculative decoding parameter predictor portion to generate forecasted embeddings and an injected bias term that result in the generation of draft tokens that more closely approximate the ground-truth tokens in the training data set 502. For example, a loss backpropagated through the generative artificial intelligence model 320 to train the self-speculative decoding parameter predictor portion may be based on a cosine similarity, a mean-squared error, or other loss measured between the forecasted embeddings 520 and the corresponding output tokens included in the output 530. Generally, the forecasted embeddings 520 may be updated based on past values of the forecasted embeddings 520 and current input context, and the injected bias term 514 may be updated based on past values of the injected bias term 514, the forecasted embeddings 520, and the current input context.

### Example Operations for Efficient Self-Speculative Decoding in Generative Artificial Intelligence Models

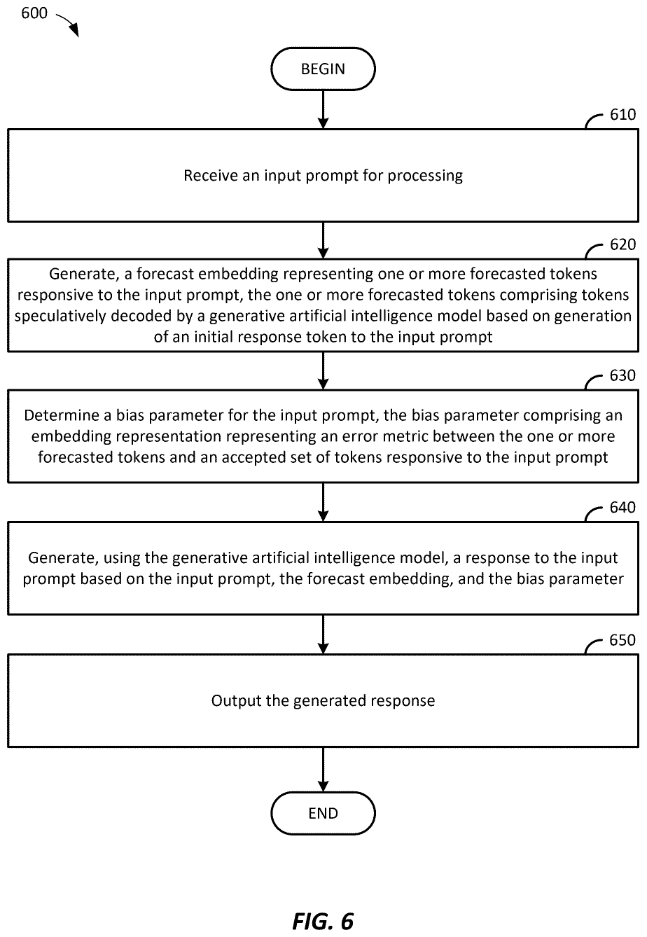

FIG. 6 illustrates example operations 600 that may be performed by a computing device to generate a response to an input prompt using generative artificial intelligence models (e.g., as discussed herein with respect to FIGS. 3 through 5), according to certain aspects of the present disclosure. The operations 600 may be performed by a computing device on which a generative artificial intelligence model can be deployed, such as a smartphone or other mobile device, a laptop computer, a desktop computer, a server, a cloud compute instance hosted in a distributed computing environment, or the like.

As illustrated, the operations 600 may begin at block 610, with receiving an input prompt for processing.

At block 620, the operations 600 proceed with generating a forecast embedding (e.g., forecasted token embeddings 314) representing one or more forecasted tokens responsive to the input prompt. The one or more forecasted tokens include tokens speculatively decoded by a generative artificial intelligence model based on generation of an initial response token in response to the input prompt.

At block 630, the operations 600 proceed with determining (e.g., providing, establishing, accessing, calculating, updating, etc.) a bias parameter (e.g., injected bias term 316 or injected bias 408) for the input prompt. The bias parameter comprises an embedding representation representing an error metric between the one or more forecasted tokens and an accepted set of tokens responsive to the input prompt.

At block 640, the operations 600 proceed with generating, using the generative artificial intelligence model, a response to the input prompt based on the input prompt, the forecast embedding, and the bias parameter.

At block 650, the operations 600 proceed with outputting the generated response.

In some aspects, the forecast embedding comprises an average calculated over embedding representations of tokens representing the input prompt. In some aspects, the operations 600 further include: (i) updating the forecast embedding based on an average of embedding representations of tokens representing the generated response and (ii) generating, using the generative artificial intelligence model, a subsequent response to the input prompt based on the input prompt and the updated forecast embedding. In some aspects, the forecast embedding may be updated online.

According to some aspects, the bias parameter is used outside of an attention computation (e.g., in a subset of attention layers).

In some aspects, the bias parameter may be a parameter calculated based on an average of attention function outputs calculated over embedding representations (or hidden-state representations) of tokens representing the input prompt. The bias parameter may be further calculated based on a scalar coefficient having a value associated with a number of tokens included in a cache (e.g., cache 318) of the generative artificial intelligence model. In some aspects, the operations 600 may further include updating the bias parameter at a time step t+1 based on a difference between the bias parameter at a time step t and a weighted average of attention function outputs calculated over embedding representations of tokens representing the generated response. Using the generative artificial intelligence model, a subsequent response to the input prompt may be generated based on the input prompt and the updated bias parameter. In some aspects, the bias parameter may be updated online.

In some aspects, the bias parameter comprises a parameter calculated based on a difference between state information associated with an accepted output of the generative artificial intelligence model and state information associated with a reference output (e.g., a ground-truth output) of the generative artificial intelligence model.

In some aspects, the bias parameter comprises a parameter calculated based on a cosine similarity between state information associated with an accepted output of the generative artificial intelligence model and state information associated with a reference output (e.g., a ground-truth output) of the generative artificial intelligence model.

In some aspects, the operations 600 may further include updating (e.g., online updating) the bias parameter at a time step t+1 based on an objective function, the bias parameter at a time step t, and a weighted average of attention function outputs calculated over embedding representations of tokens representing the generated response. Using the generative artificial intelligence model, a subsequent response to the input prompt is generated based on the input prompt and the updated bias parameter. In some aspects, the objective function comprises a cosine similarity function, and updating the bias parameter may involve maximizing cosine similarity between an accepted output of the generative artificial intelligence model and the one or more forecasted tokens.

In some aspects, the bias parameter may be a hyperparameter associated with a layer in the generative artificial intelligence model.

In some aspects, the bias parameter may be a hyperparameter associated with an attention head of the generative artificial intelligence model.

In some aspects, the generative artificial intelligence model comprises a multimodal artificial intelligence model (e.g., a large multimodal model (LMM)) configured to generate the response to the input prompt including data from one or more data modalities. In some aspects, the one or more data modalities comprise at least one of a text modality, an image data modality, or an audio data modality.

### Example Processing Systems for Efficient Self-Speculative Decoding in Generative Artificial Intelligence Models

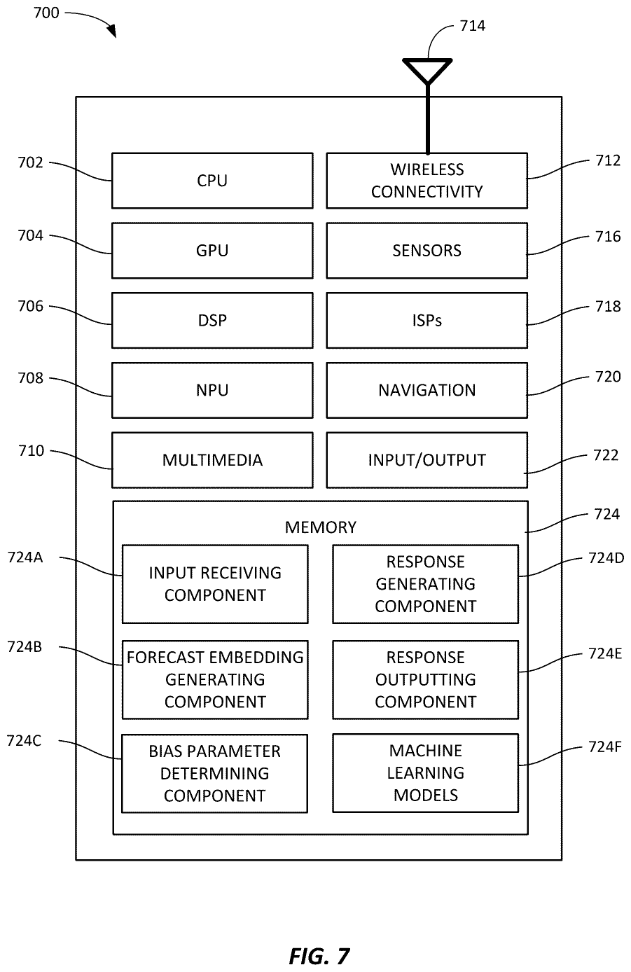

FIG. 7 depicts an example processing system 700 for generating a response to a prompt input into a generative artificial intelligence model using efficient self-speculative decoding based on the input prompt, forecasted embeddings, and an injected bias term, such as described herein, for example, with respect to FIGS. 3-6.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., of a memory 724).

The processing system 700 also includes additional processing components tailored to specific functions, such as a graphics processing unit (GPU) 704, a digital signal processor (DSP) 706, a neural processing unit (NPU) 708, and a connectivity component 712.

An NPU, such as the NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples, such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 708 is a part of one or more of the CPU 702, the GPU 704, and/or the DSP 706. These may be located on a user equipment (UE) in a wireless communication system or another computing device.

In some examples, the connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 712 may be further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes an input receiving component 724A, a forecast embedding generating component 724B, a bias parameter determining component 724C, a response generating component 724D, a response outputting component 724E, and machine learning models 724F. The depicted components, and others not depicted, may be configured to perform various aspects of the methods described herein.

Generally, the processing system 700 and/or components thereof may be configured to perform the methods described herein.

### Example Clauses

Implementation details of various aspects of the present disclosure are described in the following numbered clauses.

Clause 1: A processor-implemented method for machine learning, comprising: receiving an input prompt for processing; generating a forecast embedding representing one or more forecasted tokens responsive to the input prompt, the one or more forecasted tokens comprising tokens speculatively decoded by a generative artificial intelligence model based on generation of an initial response token in response to the input prompt; providing a bias parameter for the input prompt, the bias parameter comprising an embedding representation representing an error metric between the one or more forecasted tokens and an accepted set of tokens responsive to the input prompt; generating, using the generative artificial intelligence model, a response to the input prompt based on the input prompt, the forecast embedding, and the bias parameter; and outputting the generated response.

Clause 2: The method of Clause 1, wherein the forecast embedding comprises an average calculated over embedding representations of tokens representing the input prompt.

Clause 3: The method of Clause 2, further comprising: updating the forecast embedding based on an average of embedding representations of tokens representing the generated response; and generating, using the generative artificial intelligence model, a subsequent response to the input prompt based on the input prompt and the updated forecast embedding.

Clause 4: The method of any of Clauses 1 through 3, wherein the bias parameter comprises a parameter calculated based on an average of attention function outputs calculated over embedding representations or hidden-state representations of tokens representing the input prompt.

Clause 5: The method of Clause 4, wherein the bias parameter is further calculated based on a scalar coefficient having a value associated with a number of tokens included in a cache of the generative artificial intelligence model.

Clause 6: The method of Clause 4 or 5, further comprising: updating the bias parameter at a time step t+1 based on a difference between the bias parameter at a time step t and a weighted average of attention function outputs calculated over embedding representations of tokens representing the generated response; and generating, using the generative artificial intelligence model, a subsequent response to the input prompt based on the input prompt and the updated bias parameter.

Clause 7: The method of any of Clauses 1 through 6, wherein the bias parameter comprises a parameter calculated based on a difference between state information associated with an accepted output of the generative artificial intelligence model and state information associated with a reference output of the generative artificial intelligence model.

Clause 8: The method of any of Clauses 1 through 7, wherein the bias parameter comprises a parameter calculated based on a cosine similarity between state information associated with an accepted output of the generative artificial intelligence model and state information associated with a reference output of the generative artificial intelligence model.

Clause 9: The method of any of Clauses 1 through 8, further comprising: updating the bias parameter at a time step t+1 based on an objective function, the bias parameter at a time step t, and a weighted average of attention function outputs calculated over embedding representations of tokens representing the generated response; and generating, using the generative artificial intelligence model, a subsequent response to the input prompt based on the input prompt and the updated bias parameter.

Clause 10: The method of Clause 9, wherein the objective function comprises a cosine similarity function, and wherein updating the bias parameter comprises maximizing cosine similarity between an accepted output of the generative artificial intelligence model and the one or more forecasted tokens.

Clause 11: The method of any of Clauses 1 through 10, wherein the bias parameter comprises a hyperparameter associated with a layer in the generative artificial intelligence model.

Clause 12: The method of any of Clauses 1 through 11, wherein the bias parameter comprises a hyperparameter associated with an attention head of the generative artificial intelligence model.

Clause 13: The method of any of Clauses 1 through 12, wherein the generative artificial intelligence model comprises a multimodal artificial intelligence model configured to generate the response to the input prompt including data from one or more data modalities.

Clause 14: The method of Clause 13, wherein the one or more data modalities comprise at least one of a text modality, an image data modality, or an audio data modality.

Clause 15: A processing system comprising: at least one memory having executable instructions stored thereon; and one or more processors coupled to the at least one memory and collectively configured to execute the executable instructions in order to cause the processing system to perform the operations of any of Clauses 1 through 14.

Clause 16: A mobile device comprising the processing system of Clause 15.

Clause 17: A processing system comprising means for performing the operations of any of Clauses 1 through 14.

Clause 18: A non-transitory computer-readable medium having executable instructions stored thereon which, when executed by one or more processors of a processing system, cause the processing system to perform the operations of any of Clauses 1 through 14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
at least one memory having executable instructions stored thereon; and
one or more processors coupled to the at least one memory and collectively configured to execute the executable instructions to cause the processing system to:
receive an input prompt for processing;
generate a forecast embedding representing one or more forecasted tokens responsive to the input prompt, the one or more forecasted tokens comprising tokens speculatively decoded by a generative artificial intelligence model based on generation of an initial response token in response to the input prompt;
provide a bias parameter for the input prompt, the bias parameter comprising an embedding representation representing an error metric between the one or more forecasted tokens and an accepted set of tokens responsive to the input prompt;
generate, using the generative artificial intelligence model, a response to the input prompt based on the input prompt, the forecast embedding, and the bias parameter; and
output the generated response.

2. The processing system of claim 1, wherein the forecast embedding comprises an average calculated over embedding representations of tokens representing the input prompt.

3. The processing system of claim 2, the one or more processors being further collectively configured to execute the executable instructions to cause the processing system to:
update the forecast embedding based on an average of embedding representations of tokens representing the generated response; and
generate, using the generative artificial intelligence model, a subsequent response to the input prompt based on the input prompt and the updated forecast embedding.

4. The processing system of claim 1, wherein the bias parameter comprises a parameter calculated based on an average of attention function outputs calculated over embedding representations or hidden-state representations of tokens representing the input prompt.

5. The processing system of claim 4, wherein the bias parameter is further calculated based on a scalar coefficient having a value associated with a number of tokens included in a cache of the generative artificial intelligence model.

6. The processing system of claim 4, the one or more processors being further collectively configured to execute the executable instructions to cause the processing system to:
update the bias parameter at a time step t+1 based on a difference between the bias parameter at a time step t and a weighted average of attention function outputs calculated over embedding representations of tokens representing the generated response; and
generate, using the generative artificial intelligence model, a subsequent response to the input prompt based on the input prompt and the updated bias parameter.

7. The processing system of claim 1, wherein the bias parameter comprises a parameter calculated based on a difference between state information associated with an accepted output of the generative artificial intelligence model and state information associated with a reference output of the generative artificial intelligence model.

8. The processing system of claim 1, wherein the bias parameter comprises a parameter calculated based on a cosine similarity between state information associated with an accepted output of the generative artificial intelligence model and state information associated with a reference output of the generative artificial intelligence model.

9. The processing system of claim 1, the one or more processors being further collectively configured to execute the executable instructions to cause the processing system to:
update the bias parameter at a time step t+1 based on an objective function, the bias parameter at a time step t, and a weighted average of attention function outputs calculated over embedding representations of tokens representing the generated response; and
generate, using the generative artificial intelligence model, a subsequent response to the input prompt based on the input prompt and the updated bias parameter.

10. The processing system of claim 9, wherein the objective function comprises a cosine similarity function and wherein, to update the bias parameter, the one or more processors are collectively configured to execute the executable instructions to cause the processing system to maximize cosine similarity between an accepted output of the generative artificial intelligence model and the one or more forecasted tokens.

11. The processing system of claim 1, wherein the bias parameter comprises a hyperparameter associated with a layer in the generative artificial intelligence model.

12. The processing system of claim 1, wherein the bias parameter comprises a hyperparameter associated with an attention head of the generative artificial intelligence model.

13. The processing system of claim 1, wherein the generative artificial intelligence model comprises a multimodal artificial intelligence model configured to generate the response to the input prompt including data from one or more data modalities.

14. The processing system of claim 13, wherein the one or more data modalities comprise at least one of a text modality, an image data modality, or an audio data modality.

15. The processing system of claim 1, the one or more processors being further collectively configured to execute the executable instructions to cause the processing system to at least one of:
update the forecast embedding based on a past value of the forecast embedding and a current input context; or
update the bias parameter based on a past value of the bias parameter, the forecast embedding, and the current input context.

16. The processing system of claim 1, the one or more processors being further collectively configured to execute the executable instructions to cause the processing system to apply a bias mask to control how the bias parameter is processed by the generative artificial intelligence model in generating the response to the input prompt.

17. A mobile device comprising the processing system of claim 1.

18. A processor-implemented method for machine learning, comprising:
receiving an input prompt for processing;
generating a forecast embedding representing one or more forecasted tokens responsive to the input prompt, the one or more forecasted tokens comprising tokens speculatively decoded by a generative artificial intelligence model based on generation of an initial response token in response to the input prompt;
providing a bias parameter for the input prompt, the bias parameter comprising an embedding representation representing an error metric between the one or more forecasted tokens and an accepted set of tokens responsive to the input prompt;
generating, using the generative artificial intelligence model, a response to the input prompt based on the input prompt, the forecast embedding, and the bias parameter; and
outputting the generated response.

19. The method of claim 18, wherein the forecast embedding comprises an average calculated over embedding representations of tokens representing the input prompt.

20. The method of claim 19, further comprising:
updating the forecast embedding based on an average of embedding representations of tokens representing the generated response; and
generating, using the generative artificial intelligence model, a subsequent response to the input prompt based on the input prompt and the updated forecast embedding.

21. The method of claim 18, wherein the bias parameter comprises a parameter calculated based on an average of attention function outputs calculated over embedding representations or hidden-state representations of tokens representing the input prompt.

22. The method of claim 21, wherein the bias parameter is further calculated based on a scalar coefficient having a value associated with a number of tokens included in a cache of the generative artificial intelligence model.

23. The method of claim 21, further comprising:
updating the bias parameter at a time step t+1 based on a difference between the bias parameter at a time step t and a weighted average of attention function outputs calculated over embedding representations of tokens representing the generated response; and
generating, using the generative artificial intelligence model, a subsequent response to the input prompt based on the input prompt and the updated bias parameter.

24. The method of claim 18, wherein the bias parameter comprises a parameter calculated based on a difference between state information associated with an accepted output of the generative artificial intelligence model and state information associated with a reference output of the generative artificial intelligence model.

25. The method of claim 18, wherein the bias parameter comprises a parameter calculated based on a cosine similarity between state information associated with an accepted output of the generative artificial intelligence model and state information associated with a reference output of the generative artificial intelligence model.

26. The method of claim 18, further comprising:
updating the bias parameter at a time step t+1 based on an objective function, the bias parameter at a time step t, and a weighted average of attention function outputs calculated over embedding representations of tokens representing the generated response; and
generating, using the generative artificial intelligence model, a subsequent response to the input prompt based on the input prompt and the updated bias parameter.

27. The method of claim 26, wherein the objective function comprises a cosine similarity function, and wherein updating the bias parameter comprises maximizing cosine similarity between an accepted output of the generative artificial intelligence model and the one or more forecasted tokens.

28. The method of claim 18, wherein the bias parameter comprises a hyperparameter associated with a layer in the generative artificial intelligence model.

29. The method of claim 18, wherein the bias parameter comprises a hyperparameter associated with an attention head of the generative artificial intelligence model.

30. The method of claim 18, wherein the generative artificial intelligence model comprises a multimodal artificial intelligence model configured to generate the response to the input prompt including data from one or more data modalities.

31. The method of claim 30, wherein the one or more data modalities comprise at least one of a text modality, an image data modality, or an audio data modality.

32. The method of claim 18, further comprising at least one of:
updating the forecast embedding based on a past value of the forecast embedding and a current input context; or
updating the bias parameter based on a past value of the bias parameter, the forecast embedding, and the current input context.

33. The method of claim 18, further comprising applying a bias mask to control how the bias parameter is processed by the generative artificial intelligence model in generating the response to the input prompt.

34. An apparatus comprising:
means for receiving an input prompt for processing;
means for generating a forecast embedding representing one or more forecasted tokens responsive to the input prompt, the one or more forecasted tokens comprising tokens speculatively decoded by a generative artificial intelligence model based on generation of an initial response token in response to the input prompt;
means for providing a bias parameter for the input prompt, the bias parameter comprising an embedding representation representing an error metric between the one or more forecasted tokens and an accepted set of tokens responsive to the input prompt;
means for generating, using the generative artificial intelligence model, a response to the input prompt based on the input prompt, the forecast embedding, and the bias parameter; and
means for outputting the generated response.

35. A non-transitory computer-readable medium having executable instructions stored thereon that, when executed by one or more processors of a processing system, cause the processing system to perform operations for machine learning, the operations comprising:
receiving an input prompt for processing;
generating a forecast embedding representing one or more forecasted tokens responsive to the input prompt, the one or more forecasted tokens comprising tokens speculatively decoded by a generative artificial intelligence model based on generation of an initial response token in response to the input prompt;
providing a bias parameter for the input prompt, the bias parameter comprising an embedding representation representing an error metric between the one or more forecasted tokens and an accepted set of tokens responsive to the input prompt;
generating, using the generative artificial intelligence model, a response to the input prompt based on the input prompt, the forecast embedding, and the bias parameter; and
outputting the generated response.
